(19) United States
(12) Patent Application Publication
(10) Pub. No.: US 2026/0225743 A1
(43) Pub. Date: Aug. 6, 2026

(54) EMERGENCY VEHICLE

(71) Applicant: TOKO Life Creates Co., Ltd., Tokyo (JP)

(72) Inventor: Shinji FUKUSHIMA, Tokyo (JP)

(73) Assignee: TOKO Life Creates Co., Ltd., Tokyo (JP)

(21) Appl. No.: 19/258,032

(22) Filed: Jul. 2, 2025

(30) Foreign Application Priority Data
Feb. 4, 2025 (JP) 2025-17069

(51) Int. Cl. B64U 80/86; B60R 9/048; B60R 9/055; B60R 16/03; B64U 101/55; G09F 9/30; G09F 21/04

(52) U.S. Cl. CPC B64U 80/86; B60R 9/048; B60R 9/055; B60R 16/03; G09F 9/301; G09F 21/042; B64U 2101/55; B64U 2201/202

(57) ABSTRACT

An emergency vehicle includes: a support bracket having a ring shape; an unmanned flying body mountable on a top of a vehicle body while attached to an inner side of the support bracket, and connected to one end of a power supply line through which power is supplied from an inside of the vehicle body; a transparent cover capable of covering the unmanned flying body and openably/closably installed on the top of the vehicle body; a display member which covers a periphery and a lower side of the support bracket, whose display content is changeable, and which is bendable; and a control means configured to control an operation of the unmanned flying body and the display content of the display member.

### BACKGROUND OF THE INVENTION

### 1. Field of the Invention

The present invention relates to an emergency vehicle that is capable of fully alerting people around through a display member such as an alarm light both when the emergency vehicle is traveling and when it is stopped, while keeping the display member stably fixed to the vehicle body despite wind pressure during traveling, and in particular, that is suitable as a police vehicle such as a patrol car, a fire department vehicle such as an ambulance, and a vehicle of an expressway company.

### 2. Description of the Related Art

On various roads including expressways, many regular vehicles such as passenger cars, buses, and trucks travel in good order according to traffic signals and road signs, but congestion sometimes occurs. Meanwhile, emergent situations may occur due to accidents, emergency patients, and so on. In such emergent situations, an emergency vehicle granted priority passage irrespective of traffic signals and road signs is required, and when this emergency vehicle approaches, regular vehicles are required to stop or pull over to the shoulder of the road.

Drivers of many regular vehicles can recognize the approach of the emergency vehicle from alarm sound, the form of the emergency vehicle itself, or the like, but further, alarm light is also used for notification.

For example, emergency vehicles such as “patrol cars” and “ambulances” having a “rotating alarm light” on the top are known as police and fire department emergency vehicles, and in addition, other organizations and so on have emergency vehicles with a “rotating alarm light”. This “rotating alarm light” is used not only for notifying people around that the emergency vehicle is passing when it is traveling but also for notifying them of the presence of the emergency vehicle also when it is stopped.

Alerting people around using the “rotating alarm light” of the emergency vehicle has also been done by the passenger's operation conventionally, but in the conventional “rotating alarm light”, it has not been possible to fully change the contents of the alert by variously changing its display.

Regarding this, the following Patent Documents 1, 2 are known as prior art documents relating to an emergency vehicle and a display device. Patent Document 1 discloses an art in which an unmanned flying vehicle flying out of the emergency vehicle notifies drivers of vehicles traveling ahead of the emergency vehicle that the emergency vehicle is approaching. Further, Patent Document 2 discloses an art in which an advertising medium is suspended below a drone, and the outer peripheral surface of this advertising medium is thin and bendable.

Patent Document 1: Japanese Patent Application Laid-open No. 2019-142389

Patent Document 2: Japanese Patent No. 7024985

The art of Patent Document 1, however, cannot sufficiently alert people around both when the emergency vehicle is traveling and when it is stopped because the unmanned flying body separates from the emergency vehicle after flying out of the emergency vehicle. Further, the art of Patent Document 2 does not intend to attach the advertising medium to the emergency vehicle, and accordingly, this art including the art of Patent Document 1 involves a risk of the detachment from the body of the emergency vehicle due to wind pressure and so on when the emergency vehicle is traveling.

### SUMMARY OF THE INVENTION

Meanwhile, there has been an increasing necessity for sufficiently alerting people around both when an emergency vehicle is traveling and when it is stopped.

The present invention has been made in consideration of the above background and has an object to provide an emergency vehicle that is capable of sufficiently alerting people around through a display member such as an alarm light both when the emergency vehicle is traveling and when it is stopped, while keeping the display member stably fixed to the vehicle body even during traveling.

A first invention of the emergency vehicle includes:
a support bracket having a ring shape;
an unmanned flying body mountable on a top of a vehicle body while attached to an inner side of the support bracket, and connected to one end of a power supply line through which power is supplied from an inside of the vehicle body;
a transparent cover capable of covering the unmanned flying body and openably/closably installed on the top of the vehicle body;
a display member which covers a periphery and a lower side of the support bracket, whose display content is changeable, and which is bendable; and
a control means configured to control an operation of the unmanned flying body and the display content of the display member.

The following describes the effects of the first invention of the emergency vehicle.

According to this invention of the emergency vehicle, the unmanned flying body connected to the end of the power supply line through which the power is supplied from the inside of the vehicle body is mountable on the top of the vehicle body while attached to the inner side of the ring-shaped support bracket, and the transparent cover openably/closably installed on the top of the vehicle body can cover the unmanned flying body. Further, the display member whose display content is changeable and which is bendable covers the periphery and the lower side of the support bracket, and the control means controls the operation of the unmanned flying body and the display content of the display member.

With this configuration, when the emergency vehicle is traveling, the unmanned flying body does not operate, and the transparent cover is closed to cover the unmanned flying body. However, part of the display member covering the periphery of the support bracket displays necessary information so that people around can be alerted. On the other hand, when the emergency vehicle is stopped, the transparent cover is opened and the control means activates the unmanned flying body, so that the unmanned flying body flies up from the vehicle body while the bent display member is stretched. This makes it possible to alert people around in a wider range using the entire display member while, for example, changing the display contents.

As described above, according to the emergency vehicle of this invention, since the control means activates the unmanned flying body only when necessary and controls the display range and contents of the display member, it is possible to sufficiently alert people around through the display member both when the emergency vehicle is traveling and when it is stopped, while stably fixing the display member to the vehicle body despite wind pressure and so on during traveling.

A second invention of the emergency vehicle includes:
a support bracket having a ring shape;
an unmanned flying body mountable on a top of a vehicle body while attached to an inner side of the support bracket, and connected to one end of a power supply line through which power is supplied from an inside of the vehicle body;
a transparent cover with a dome shape made of a transparent glass material or synthetic resin material, capable of covering the unmanned flying body, and openably/closably installed on the top of the vehicle body;
a display member which covers a periphery and a lower side of the support bracket, whose display content is changeable, and which is bendable; and
a control means configured to control an operation of the unmanned flying body and the display content of the display member.

The second invention of the emergency vehicle has the same effects as those of the first invention. In addition, since the transparent cover thus has the dome shape and is made of the transparent glass material or synthetic resin member having necessary strength, the surer alert through the display of the display member is achieved even when the unmanned flying body is mounted on the top of the vehicle body as it is housed inside the transparent cover.

A third invention of the emergency vehicle includes:
a support bracket having a ring shape;
an unmanned flying body mountable on a top of a vehicle body while attached to an inner side of the support bracket, and connected to one end of a power supply line through which power is supplied from an inside of the vehicle body;
a transparent cover capable of covering the unmanned flying body and openably/closably installed on the top of the vehicle body;
a display member which covers a periphery and a lower side of the support bracket, whose display content is changeable, and which is bendable; and
a control means configured to determine whether the emergency vehicle is stopped or is traveling and control an operation of the unmanned flying body by supplying the power only when the emergency vehicle is stopped and stopping the supply of the power to the unmanned flying body when the emergency vehicle is traveling, and control the display content of the display member.

The third invention of the emergency vehicle has the same effects as those of the first invention. In addition, since the control means thus determines whether the emergency vehicle is traveling or stopped, not only the unmanned flying body can be operated safely but also the display member can display various contents according to the determination by the control means on whether the emergency vehicle is traveling or stopped.

Further, in each of the above-described inventions, a possible configuration is that the transparent cover is openably/closably installed with a base end side of the transparent cover being attached to the top of the vehicle body with a hinge. Another possible configuration is that the display member has a circular tube shape or a quadrilateral tube shape, and besides, the display member is a thin and bendable organic EL display, and the power is suppliable also to the organic EL display through the power supply line.

Since the display member thus has the tube shape, the display member can be light-weighted as well as being bendable, and it is stretched from the folded state when necessary, making it possible to surely alert people around in a wider range using the entire display member. Further, since the display member is the bendable organic EL display that can be supplied with power through the power supply line, it is possible to easily control the change of the display contents.

Another possible configuration is that a mooring cable is arranged between a bottom of the display member and the top of the vehicle body, and the mooring cable connects the display member to the vehicle body. Thus connecting the display member to the vehicle body by the mooring cable prevents the display member from being blown off accidentally together with the unmanned flying body due to strong wind or the like. In addition, by adjusting the length of the mooring cable, it is possible to arrange the display member at a necessary height, enabling a change of an alerted range.

Other possible configurations are that an upper part of the display member is supported by the support bracket and a lower part of the display member is bendable, and the control means determines whether the emergency vehicle is stopped or traveling to make the entire display member display the content when the emergency vehicle is stopped and make part of the display member display the content when the emergency vehicle is traveling.

The emergency vehicle according to the present invention has an excellent effect of being capable of fully alerting people around through the display member such as an alarm light both when the emergency vehicle is traveling and when it is stopped, while keeping the display member stably fixed to the vehicle body even when the emergency vehicle is traveling.

### BRIEF DESCRIPTION OF THE DRAWINGS

FIG. 1 is a block diagram of an emergency vehicle according to one embodiment of the present invention.

FIG. 2 is a perspective view of the emergency vehicle according to the embodiment of the present invention in a traveling state.

FIG. 3 is a sectional view illustrating the vicinity of a transparent cover when the emergency vehicle according to the embodiment of the present invention is in the traveling state.

FIG. 4 is a perspective view of a support bracket used in the emergency vehicle according to the embodiment of the present invention as viewed from a lower side.

FIG. 5 is a perspective view of an unmanned flying body and a display member when the emergency vehicle according to the embodiment of the present invention is in the traveling state.

FIG. 6 is a perspective view of the emergency vehicle according to the embodiment of the present invention in a stopped state.

FIG. 7 is a sectional view illustrating the vicinity of the transparent cover when the emergency vehicle according to the embodiment of the present invention is in the stopped state.

FIG. 8 is a perspective view of the unmanned flying body and the display member when the emergency vehicle according to the embodiment of the present invention is in the stopped state.

### DETAILED DESCRIPTION OF THE PREFERRED EMBODIMENT

One embodiment of an emergency vehicle according to the present invention will be hereinafter described in detail with reference to the drawings.

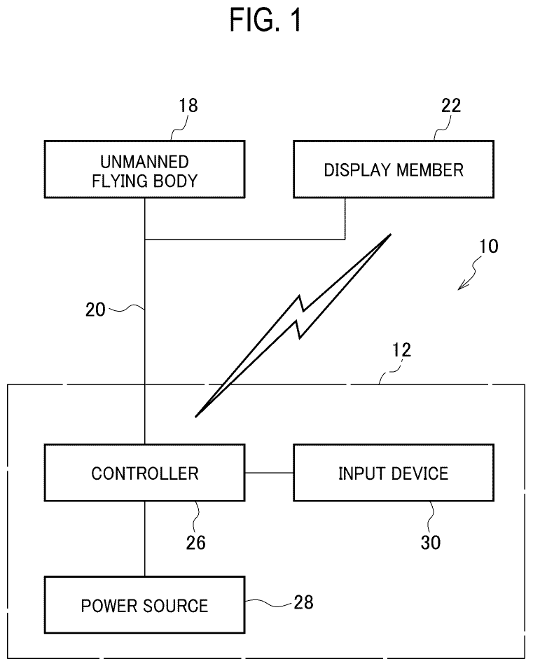

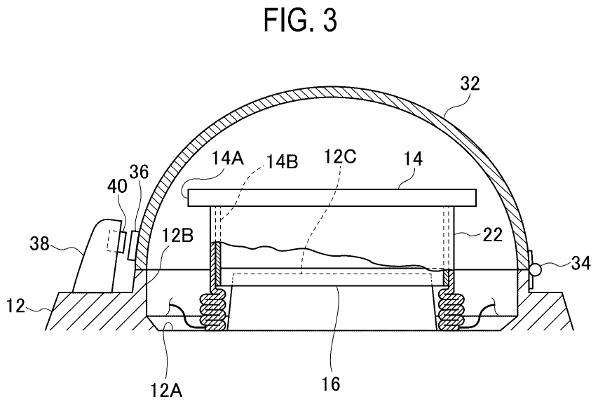

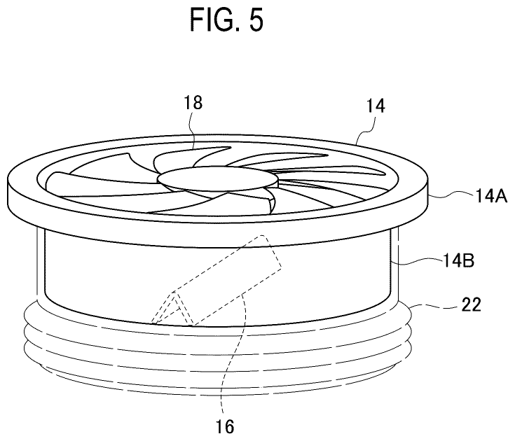

On the top of a vehicle body 12 of an emergency vehicle 10, which is a patrol car, of this embodiment illustrated in FIG. 1, a recess 12A where various members can be housed is formed as illustrated in FIG. 3. Note that around the recess 12A, a slightly higher annular wall part 12B is provided for waterproofing. Inside the recess 12A, a ring-shaped support bracket 14 having a circular outer shape and an unmanned flying body 18, which is illustrated in FIG. 1 and FIG. 5 and is a so-called drone, attached to the inner side of the support bracket 14 are arranged, and one end of a power supply line 20 through which power is supplied from the inside of the vehicle body 12 of the emergency vehicle 10 is connected to the unmanned flying body 18.

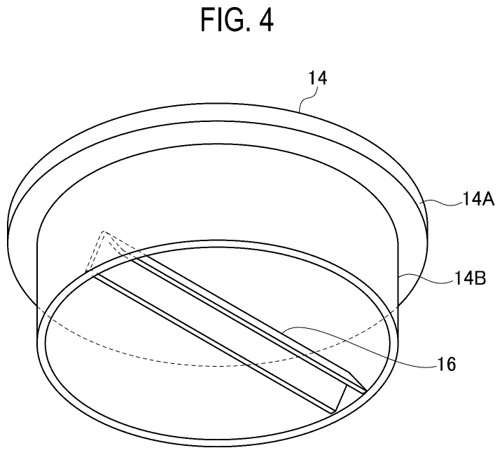

As illustrated in FIG. 4, the support bracket 14 has an upper part 14A and a ring-shaped lower part 14B smaller in outside diameter than the upper part 14A, and a connecting member 16 in an inverted V shape for connection to the vehicle body 12 extends between lower edge positions of the lower part 14B. An upper part of a display member 22, which is a red rotating alarm light, having a circular tube shape is attached to the lower part 14B of the support bracket 14 to cover the periphery and lower side of the lower part 14B of the support bracket 14.

The display member 22 is a thin and bendable organic EL display, and the power supply line 20 is also connected to the display member 22 so that power can be supplied to the display member 22. Further, when the unmanned flying body 18 is stopped, the connecting member 16 of the support bracket 14 is engaged with a ridge-shaped guide member 12C provided in the recess 12A. At this time, a lower part of the display member 22 except its part attached to the support bracket 14 is folded and the length of the display member 22 becomes about ⅓ of that when the unmanned flying body 18 is in operation and flying up.

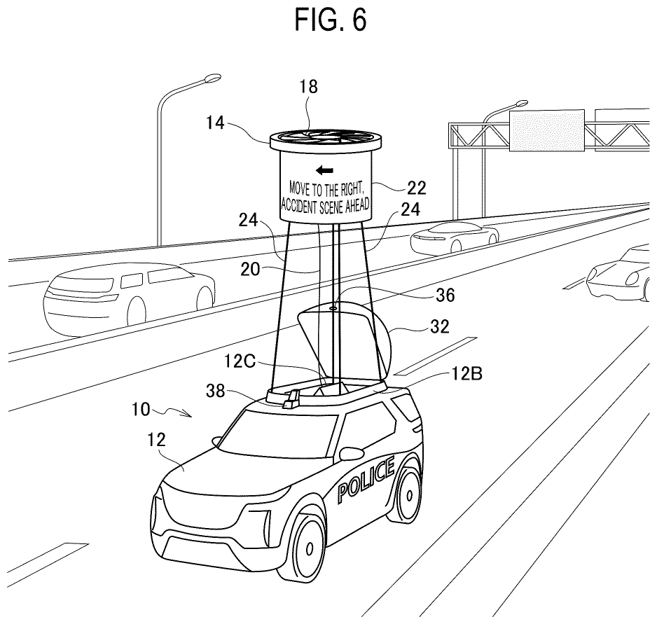

As illustrated in FIG. 6, between the bottom of the display member 22 and the top of the vehicle body 12, for example, four mooring cables 24 made of a metal or a synthetic resin are arranged, and the mooring cables 24 connect the bottom of the display member 22 to the vehicle body 12.

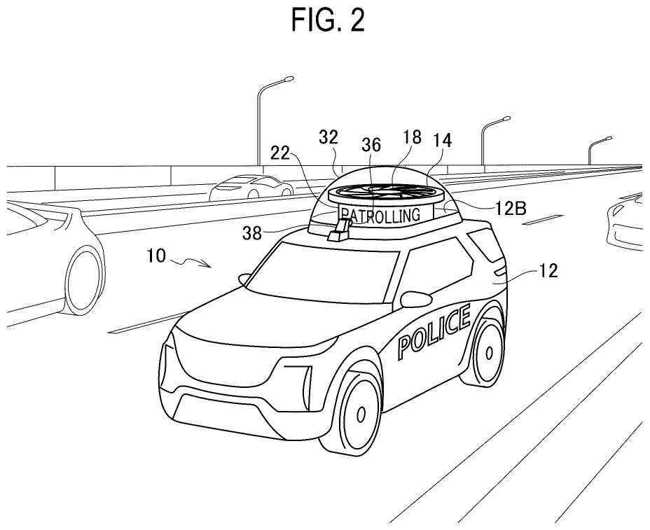

As illustrated in FIG. 1, a controller 26, which is a control means to control the operation of the unmanned flying body 18 and the display contents and display range of the display member 22, is provided in the vehicle body 12 of the emergency vehicle 10, and the controller 26 determines whether the emergency vehicle 10 is stopped or traveling. Therefore, under the control by the controller 26, it is possible to supply power from a power source 28 such as a battery in the vehicle body 12 to the unmanned flying body 18 through the power supply line 20 only when the emergency vehicle 10 is in the stopped state illustrated in FIG. 6, while stopping the supply of the power to the unmanned flying body 18 when the emergency vehicle 10 is in the traveling state illustrated in FIG. 2.

The controller 26 is capable of changing not only the display contents of the display member 22 but also its display range. Specifically, the display range can be changed between the entire display member 22 and an upper ⅓ portion of the display member 22. Further, not only the display contents of the display member 22 are prepared in various kinds in advance but also the display contents can be input from an in-vehicle input device 30 illustrated in FIG. 1. Further, the display contents are wirelessly sent to a receiving unit in the display member 22 from the controller 26 so that the display contents of the display member 22 can be changed.

On the top of the vehicle body 12, a dome-shaped transparent cover 32 made of a transparent glass material or synthetic resin material is arranged on the periphery of the above-mentioned recess 12A. As illustrated in FIG. 3, the transparent cover 32 is openably/closably installed with its base end side being attached to the annular wall part 12B with a hinge 34 provided on the top of the vehicle body 12. As illustrated in FIG. 2 and FIG. 3, the transparent cover 32 in the closed state covers the stopped unmanned flying body 18 and the folded display member 22.

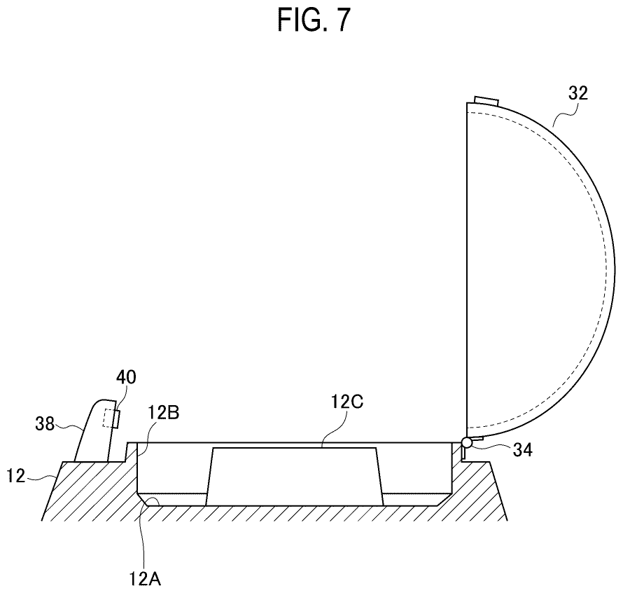

Further, a metal member 36 of steel or the like that reacts to magnetism is fixed to the other end of the transparent cover 32 with a not-illustrated screw. On the top of the vehicle body 12 of the emergency vehicle 10, a closing member 38 having a magnet 40 is arranged to face the metal member 36. Owing to the magnet 40 facing the metal member 36, the transparent cover 32 can be surely fixed to the top of the vehicle body 12 by the magnetic force of the magnet 40 when the emergency vehicle 10 is traveling, while being allowed to open when necessary. Note that when the emergency vehicle 10 is stopped, the transparent cover 32 is openable against the magnetic force of the magnet 40 as illustrated in FIG. 6 and FIG. 7.

Next, the operation of the emergency vehicle 10 of this embodiment will be described.

According to the emergency vehicle 10 of this embodiment, the unmanned flying body 18 connected to the end of the power supply line 20 through which power is supplied from the inside of the vehicle body 12 is mountable on the top of the vehicle body 12 while attached to the inner side of the ring-shaped support bracket 14. Further, the dome-shaped transparent cover 32 made of the transparent glass material or synthetic resin material having necessary strength is openably/closably installed with its base end side being attached to the top of the vehicle body 12 with the hinge 34.

The transparent cover 32 covers the unmanned flying body 18 in the stopped state and the display member 22. The display member 22 can display the display contents while the display contents are changeable, is the organic EL display, is bendable, and has a circular tube shape. Further, the display member 22 covers the periphery and the lower side of the lower part 14B of the support bracket 14, and the controller 26 controls the operation of the unmanned flying body 18 and the display contents and display range of the display member 22. Further, employing the transparent cover 32 makes it possible to surely alert people around through the display on the upper part of the display member 22 even when the unmanned flying body 18 is mounted on the top of the vehicle body 12 as it is housed in the transparent cover 32.

Further, the display member 22 can also be supplied with power through the power supply line 20, and in addition, the display member 22 is connected to the vehicle body 12 by the mooring cables 24 present between the bottom of the display member 22 and the top of the vehicle body 12. This not only prevents the display member 22 from being blown off accidentally together with the unmanned flying body 18 due to strong wind or the like, but also makes it possible to change an alerted range because it is possible to arrange the display member 22 at a necessary height by adjusting the length of the mooring cables 24

Meanwhile, the controller 26 determines whether the emergency vehicle 10 is stopped or traveling, and supplies power to the unmanned flying body 18 only when the emergency vehicle 10 is stopped, while stopping the supply of power to the unmanned flying body 18 when the emergency vehicle 10 is traveling. Therefore, when the emergency vehicle 10 is in the traveling state illustrated in FIG. 2, the operation of the unmanned flying body 18 is stopped, and the transparent cover 32 is closed to cover the unmanned flying body 18. However, under the control by the controller 26, the upper part, of the display member 22, covering the periphery of the support bracket 14 displays necessary information, for example, “patrolling” so that people around can be alerted.

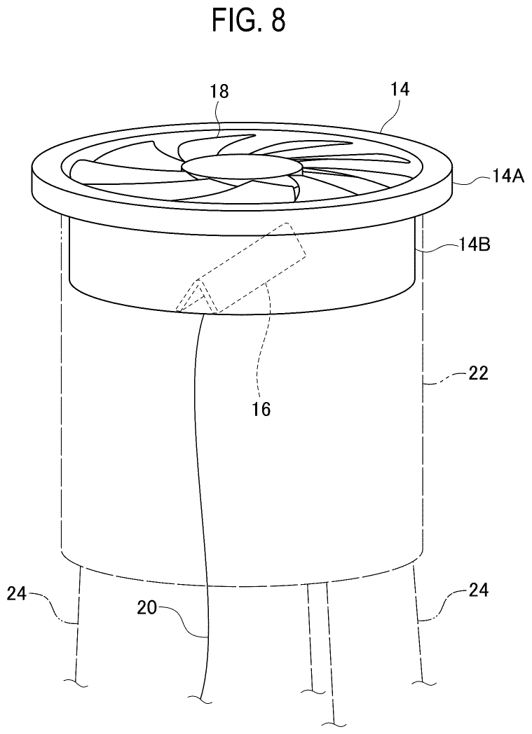

On the other hand, when the emergency vehicle 10 is in the stopped state illustrated in FIG. 6, the transparent cover 32 is opened as illustrated in FIG. 7, and the controller 26 activates the unmanned flying body 18, so that the unmanned flying body 18 flies up from the vehicle body 12 while the bent display member 22 is stretching as illustrated in FIG. 8. This makes it possible to alert people around in a wider range through the display on the entire display member 22 while changing the display contents to, for example, “MOVE TO THE RIGHT, ACCIDENT SCENE AHEAD”, under the control by the controller 26.

As described above, according to the emergency vehicle 10 of this embodiment, the controller 26 activates the unmanned flying body 18 only when necessary and controls the display range and display contents of the display member 22. Accordingly, it is possible to sufficiently alert people around through the display member 22 both when the emergency vehicle 10 is traveling and when it is stopped, while stably fixing the transparent cover 32 to the vehicle body 12 by the magnetic force of the magnet 40 despite wind pressure when the emergency vehicle 10 is traveling. Moreover, since the controller 26 determines whether the emergency vehicle 10 is traveling or stopped, not only the unmanned flying body 18 can be safely operated but also the display member 22 can display various contents.

Since the display member 22 is not only the thin and bendable organic EL display and is supplied with power through the power supply line but also has the circular tube shape, the display member 22 can be light-weighted as well as being bendable. Further, it is stretched from the folded state when necessary, ensuring that people around in a wider range is alerted by the entire display member 22. Further, not only the display member 22 is bendable but also its display contents can be easily changed.

In the above-described embodiment, though the receiver is employed for the receipt from the controller 26, the controller 26 and the display member 22 may be directly connected with a cable instead of using the receiver. Further, in the above-described embodiment, the display member 22 is the red rotating alarm light, but yellow or blue may be used depending on its use. Further, in the above-described embodiment, the display member 22 has the circular tube shape, but may have a polygonal tube shape such as a quadrilateral tube shape. In this case, however, the outer shape of the lower part 14B of the support bracket 14 needs to be a polygonal tube shape.

The display member 22 is the bendable organic EL display, and as the organic EL display, a thin and light flexible organic EL display recently developed by NHK Science & Technology Research Laboratories of Japan Broadcasting Corporation is adoptable. This flexible organic EL display, which is 30-inch 4K, has a 0.5 mm thickness and a 100 gram weight and is bendable or rollable for storage. However, the display member 22 may be not only the organic EL display but also a known display.

In the above-described embodiment, the dome-shaped transparent cover 32 is made of the transparent glass material or synthetic resin material, and possible examples of the synthetic resin material include acrylic, polyethylene terephthalate, polystyrene, and polyvinyl chloride. Further, the magnet 40 used in the above-described embodiment may be not only a typical ferrite magnet but also a rare-earth magnet such as a samarium-cobalt magnet or a neodymium magnet, but the method of fixing the transparent cover 32 may be any other typical method.

Though the battery of the emergency vehicle 10 is the power source 28, it itself may be another large battery or a power generator capable of power generation. Further, in the above-described embodiment, though the control means is the controller, the control means may be a computer or the like, and as for the control method, a program or data may be input in advance, or the unmanned flying body 18 may be directly operated wirelessly or via a cable.

Hitherto, the embodiment according to the present invention has been described, but the present invention is not limited to such an embodiment and may be embodied in various modified forms without departing from the spirit of the present invention.

The present invention is applicable not only to a police vehicle, such as a patrol car, and an ambulance but also to other officially authorized emergency vehicles of other organizations or the like, and is also applicable to various other industrial fields.

What is claimed is:

1. An emergency vehicle comprising:
a support bracket having a ring shape;
an unmanned flying body mountable on a top of a vehicle body while attached to an inner side of the support bracket, and connected to one end of a power supply line through which power is supplied from an inside of the vehicle body;
a transparent cover capable of covering the unmanned flying body and openably/closably installed on the top of the vehicle body;
a display member which covers a periphery and a lower side of the support bracket, whose display content is changeable, and which is bendable; and
a control means configured to control an operation of the unmanned flying body and the display content of the display member.

2. The emergency vehicle according to claim 1, wherein the transparent cover is openably/closably installed with a base end side of the transparent cover being attached to the top of the vehicle body with a hinge.

3. The emergency vehicle according to claim 1, wherein the display member has a circular tube shape or a quadrilateral tube shape.

4. The emergency vehicle according to claim 1, wherein the display member is a thin and bendable organic EL display, and the power is suppliable also to the organic EL display through the power supply line.

5. The emergency vehicle according to claim 1, wherein a mooring cable is arranged between a bottom of the display member and the top of the vehicle body, and the mooring cable connects the display member to the vehicle body.

6. The emergency vehicle according to claim 1, wherein an upper part of the display member is supported by the support bracket, and a lower part of the display member is bendable.

7. The emergency vehicle according to claim 1, wherein the control means determines whether the emergency vehicle is stopped or traveling to make the entire display member display the content when the emergency vehicle is stopped and make part of the display member display the content when the emergency vehicle is traveling.

8. An emergency vehicle comprising:
a support bracket having a ring shape;
an unmanned flying body mountable on a top of a vehicle body while attached to an inner side of the support bracket, and connected to one end of a power supply line through which power is supplied from an inside of the vehicle body;
a transparent cover with a dome shape made of a transparent glass material or synthetic resin material, capable of covering the unmanned flying body, and openably/closably installed on the top of the vehicle body;
a display member which covers a periphery and a lower side of the support bracket, whose display content is changeable, and which is bendable; and
a control means configured to control an operation of the unmanned flying body and the display content of the display member.

9. The emergency vehicle according to claim 8, wherein the transparent cover is openably/closably installed with a base end side of the transparent cover being attached to the top of the vehicle body with a hinge.

10. The emergency vehicle according to claim 8, wherein the display member has a circular tube shape or a quadrilateral tube shape.

11. The emergency vehicle according to claim 8, wherein the display member is a thin and bendable organic EL display, and the power is suppliable also to the organic EL display through the power supply line.

12. The emergency vehicle according to claim 8, wherein a mooring cable is arranged between a bottom of the display member and the top of the vehicle body, and the mooring cable connects the display member to the vehicle body.

13. The emergency vehicle according to claim 8, wherein an upper part of the display member is supported by the support bracket, and a lower part of the display member is bendable.

14. The emergency vehicle according to claim 8, wherein the control means determines whether the emergency vehicle is stopped or traveling to make the entire display member display the content when the emergency vehicle is stopped and make part of the display member display the content when the emergency vehicle is traveling.

15. An emergency vehicle comprising:
a support bracket having a ring shape;
an unmanned flying body mountable on a top of a vehicle body while attached to an inner side of the support bracket, and connected to one end of a power supply line through which power is supplied from an inside of the vehicle body;
a transparent cover capable of covering the unmanned flying body and openably/closably installed on the top of the vehicle body;
a display member which covers a periphery and a lower side of the support bracket, whose display content is changeable, and which is bendable; and
a control means configured to determine whether the emergency vehicle is stopped or traveling and control an operation of the unmanned flying body by supplying the power only when the emergency vehicle is stopped and stopping the supply of the power to the unmanned flying body when the emergency vehicle is traveling, and control the display content of the display member.

16. The emergency vehicle according to claim 15, wherein the transparent cover is openably/closably installed with a base end side of the transparent cover being attached to the top of the vehicle body with a hinge.

17. The emergency vehicle according to claim 15, wherein the display member has a circular tube shape or a quadrilateral tube shape.

18. The emergency vehicle according to claim 15, wherein the display member is a thin and bendable organic EL display, and the power is suppliable also to the organic EL display through the power supply line.

19. The emergency vehicle according to claim 15, wherein a mooring cable is arranged between a bottom of the display member and the top of the vehicle body, and the mooring cable connects the display member to the vehicle body.

20. The emergency vehicle according to claim 15, wherein the control means determines whether the emergency vehicle is stopped or traveling to make the entire display member display the content when the emergency vehicle is stopped and make part of the display member display the content when the emergency vehicle is traveling.
